(19) United States
(12) Patent Application Publication
(10) Pub. No.: US 2003/0100394 A1
(43) Pub. Date: May 29, 2003

(54) Drill drive train bearing assembly

(76) Inventor: Richard Kuchta, Shickshinny, PA (US)

Correspondence Address: Richard R. Michaud, McCormick, Paulding & Huber LLP, CityPlace II, 185 Asylum Street, Hartford, CT, 06103-3402, US

(21) Appl. No.: 09/995,094

(22) Filed: Nov. 27, 2001

(51) Int. Cl. F16H 7/14

(52) U.S. Cl. 474/118

(57) ABSTRACT

The drive train bearing assembly and actuator having a shaft defining a longitudinal axis and movable between an extended and a retracted position defines a bore extending therethrough. A spindle is positioned in the bore and coupled for rotation to the actuator shaft. A pulley is positioned over an end of the actuator shaft and spindle that has a bearing located therein. The bearing extends between the pulley and the actuator shaft and is coupled to the pulley so that the pulley and the spindle rotate together relative to the actuator shaft.

### FIELD OF THE PRESENT INVENTION

The present invention is generally directed to bearing assemblies and is more particularly directed to a bearing assembly for use in belt-driven machine tools.

### BACKGROUND OF THE PRESENT INVENTION

The present invention has general utility with respect to machinery that incorporates relatively long spindles adapted to carry cutting tools, such as drill bits. One such machine is a triple drill, a drill having three independently operable spindles each adapted to releasably retain a drill bit. However, while the apparatus described and illustrated herein below is particularly suitable for use with the present invention, it should be understood that the invention is not limited in this regard.

In general, machine tools such as drilling machines, milling machines, and the like, employ spindles adapted to releasably retain a cutting tool. During a cutting operation, high torques are generated and transmitted through the spindle, and the pulley coupled thereto. A problem associated with machine tools employing relatively long, often movable spindles is that the spindle tends to deflect as a result of machining forces generated and exerted there against. Another problem associated with the forces due to machining is that they tend to place large loads on the bearings supporting the spindle.

This problem is exacerbated when the spindle is belt driven, as the belt must be appropriately tensioned to transmit torque to the spindle, otherwise during operation, the belt will slip causing machining errors and/or damage to the cutting tool. However, the tension on the belt further adds to the forces exerted on the spindle bearings. Since these forces can be high, and are often asymmetrical, the bearings must be frequently lubricated, and often replaced.

Based on the foregoing, it is the general object of the present invention to provide a spindle drive system that overcomes the problems and drawbacks of prior art systems.

### SUMMARY OF THE PRESENT INVENTION

The present invention is directed in one aspect to a drive train bearing assembly that includes an actuator having a shaft defining a longitudinal axis and being movable between an extended position and a retracted position. The shaft defines an axial bore extending therethrough with a spindle positioned in the bore and coupled for rotation to the actuator shaft. A pulley also defining an axial bore extending therethrough has a bearing positioned therein so that when said pulley is located over said actuator shaft said bearing and thereby said pulley are coupled for rotation relative to the actuator shaft. The spindle is coupled to the pulley so that the pulley and spindle can rotate together relative to the actuator shaft.

In the preferred embodiment of the present invention the sleeve is fixedly mounted to the actuator shaft between the pulley and shaft so that the bearing located in the pulley engages the sleeve. A second bearing is positioned in the sleeve and is adapted to rotatably receive a portion of the spindle. A cutting tool chuck is mounted on to the end of the spindle opposite the pulley with yet another bearing being mounted to the actuator shaft and extending between the actuator shaft and the spindle in the area of the chuck.

Preferably the actuator is a pneumatic cylinder, however the present invention is not limited in this regard as other actuators known to those skilled in the pertinent art to which the invention pertains such as a hydraulic cylinder can be substituted without the departing from the broader aspects of the present invention. In addition it is preferable that the bearing extending between the pulley and the sleeve is a needle type bearing.

The present invention has the advantage of having a three bearing spindle and bearing mounting system with one of the bearings being a needle type bearing having line contact with the sleeve attached to the actuator shaft so that the entire spindle assembly is stiff and resists deflection while still being able to accommodate high operating loads and speeds.

### BRIEF DESCRIPTION OF THE DRAWINGS

FIG. 1 is a partial front elevational view of a triple drill embodying the present invention.

FIG. 2 is a partial cross sectional, side elevational view of the triple drill of FIG. 1.

FIG. 3 is a partial cross-sectional view taken along lines 3-3 of FIG. 2, showing the drive and driven pulleys as well as a first and second belt, the second belt being engaged by an idler pulley.

FIG. 4 is a side elevational view of the idler pulley and bracket of FIG. 3 showing the means for adjusting the position of the idler pulley.

FIG. 5 is an exploded view showing the spindle assembly having one of the driven pulleys of FIG. 4 attached thereto.

### DETAILED DESCRIPTION OF THE PREFERRED EMBODIMENT OF THE PRESENT INVENTION

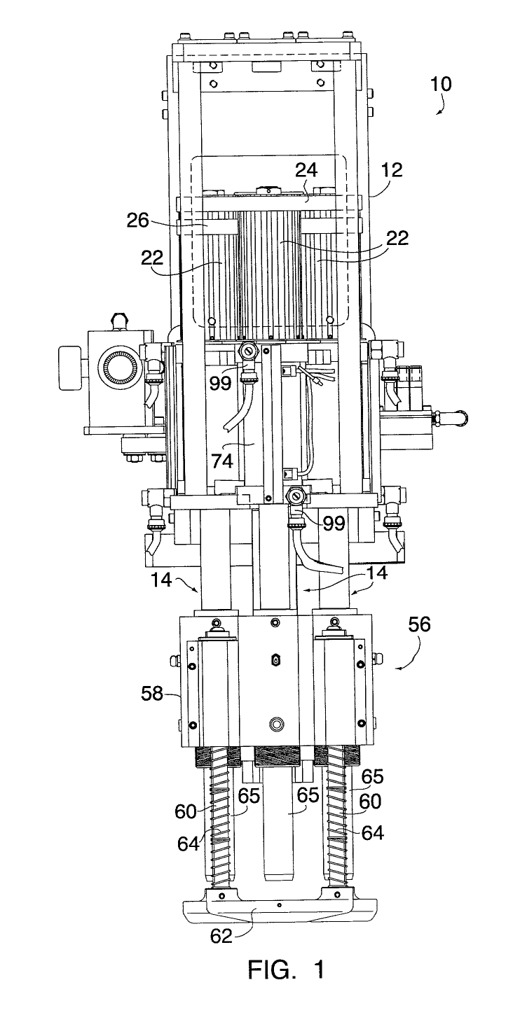

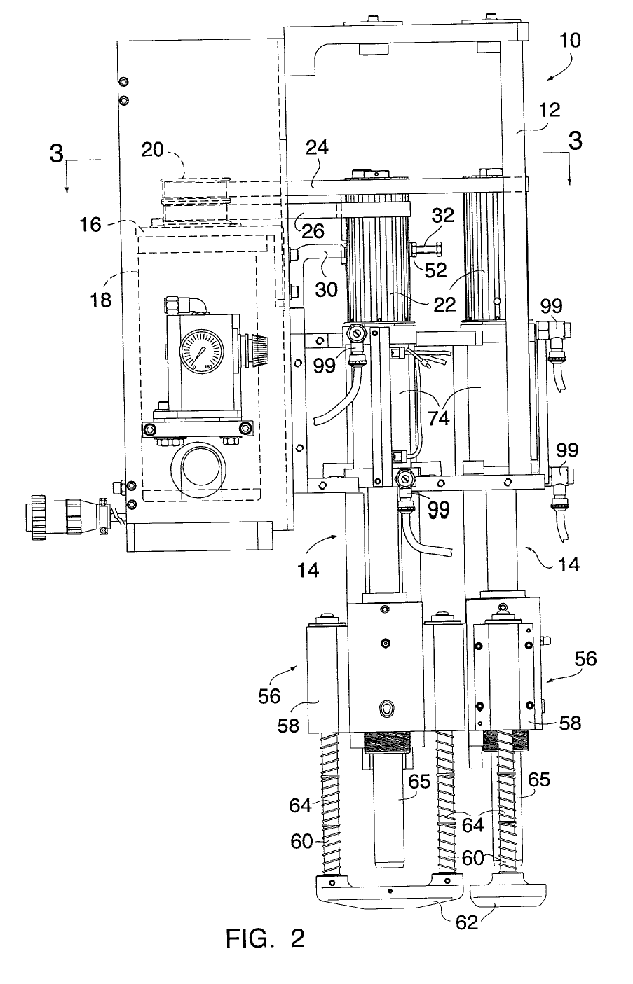

As shown in FIGS. 1 and 2, a triple drill generally designated by the reference number 10 includes a housing 12, and three separate spindle assemblies, explained in detail herein below and generally designated by the reference number 14. Referring to FIG. 2, a motor bracket 16 is attached to the housing 12 and has a motor 18 (shown in dotted lines in FIG. 2) fastened thereon. A drive pulley 20 (also shown in dotted lines in FIG. 2) is coupled for rotation to the motor 18. In addition, a driven pulley 22 is mounted for rotation to each of the spindle assemblies 14.

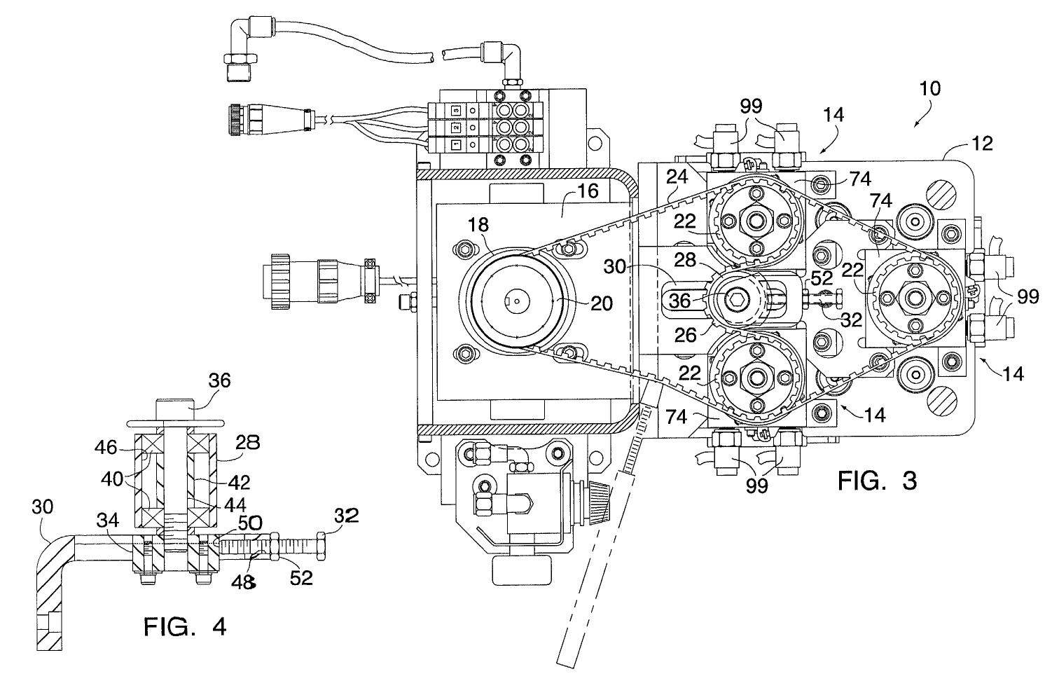

As shown in FIGS. 1 and 2, and particularly in FIG. 3, a first drive belt 24 extends around the drive pulley 20 and each driven pulley 22. The driven pulleys 22 are arranged in a triangular pattern with the drive pulley 20 being positioned opposite to and aligned with the driven pulley 22 forming the apex of the triangular pattern, as such, the first belt 24 minimally engages the periphery of the driven pulleys 22 closest to the drive pulley and extends approximately half or 180° around the periphery of the driven pulley at the apex of the triangular pattern. During operation, the driven pulley 22 at the apex of the triangular pattern is sufficiently engaged by the first belt 24 to transmit an appropriate operating torque to the spindle 14 to which it is coupled. However, the two driven pulleys 22 closest to the drive pulley 20 are not sufficiently engaged by the first belt 24 to transmit the desired operating torque. Accordingly, a second belt 26 engages the drive pulley 20 and the two driven pulleys 22 closest thereto.

Still referring to FIG. 3, it is preferable that the two driven pulleys 22 closest to the drive pulley 20, be engaged by the second belt 26 over approximately 180 degrees of the peripheries defined by each driven pulley. To accomplish this, the second belt 26 must be deformed between the driven pulleys 22. Thus is facilitated by an idler pulley 28 mounted for rotation to a bracket 30 that in turn is mounted to the frame 12. The idler pulley 28 is movable relative to the frame 12 by turning the adjusting screw 32, to increase, or decrease, depending on the direction in which the adjusting screw is turned, the tension in the second belt 26, as well as to increase or decrease the amount of belt engagement between the second belt 26 and the driven pulleys 22. While cog type belts and pulleys have been shown and described in the illustrated embodiment, the present invention is not limited in this regard as other types of belts and pulleys, known to those skilled in the pertinent art to which the present invention pertains, may be substituted without departing from the broader aspects of the present invention. For example, V-belts and sheaves, or flat belts and pulleys can be employed in place of the above-described cog belts and pulleys.

As shown in FIG. 4 the idler pulley 28 is mounted to the bracket 30 via a support 34. A fastener 36 extends through the idler pulley 28 and threadably engages the support 34. A pair of bearings 40 separated by a spacer 42 are located over an outer diameter 44 defined by a fastener 36 and engage an inner diameter 46 of the idler pulley 28. The adjusting screw 32 threadably engages an aperture 48 defined by the bracket 30 and includes an end 50 that engages the support 34. A lock nut 52 is threaded onto the adjusting screw 32 and can be tightened against the bracket 32 to releasably lock the idler pulley in a desired location.

Referring back to FIGS. 1 and 2, the triple drill 10 includes three spindle assemblies 14 generally parallel with one another and extending outwardly from the housing 12. Each of the spindle assemblies 14 is mounted for rotation to the frame and has a presser foot assembly generally designated by the reference number 56 mounted thereon. Each presser foot assembly 56 includes a presser foot support 58 having a pair of guide rods 60 slidably extending therefrom. A presser foot 62 is attached to the ends of the pair of guide rods 60 and a coil spring 64 is positioned over each guide rod 60 between the presser foot 62 and the presser foot support 58. During operation of the triple drill 10, one of the spindle assemblies 14, which are movable between a raised and a lowered position, is moved into engagement with the media to be drilled. Depending on the thickness of the media, the presser foot 62 via the pair of guide rods 60 sliding into or out of the presser foot support 58 moves up or down and is urged toward the media via the springs 64. As will be explained in detail a portion of the spindle assembly, having a cutting tool 65, shown in the illustrated embodiment as a drill bit is lowered so that the drill engages and machines the media to be drilled.

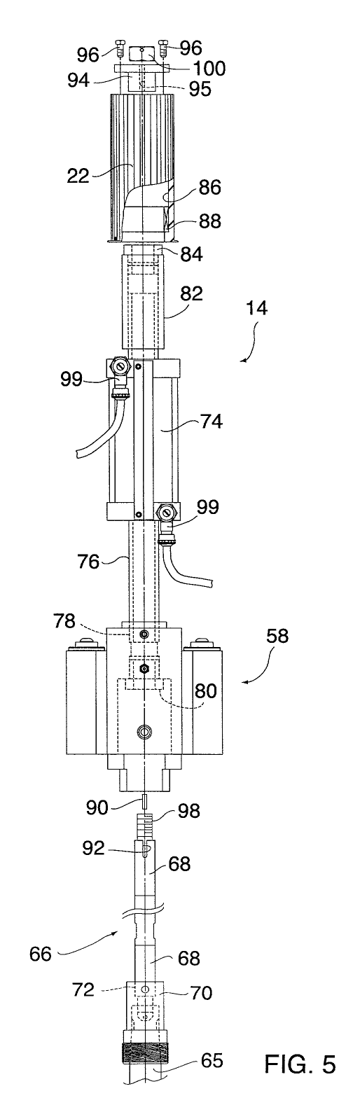

As shown in FIG. 5, the spindle assembly 14 includes a spindle shaft generally designated by the reference number 66 having bearing journals 68 machined at opposite ends thereof. A chuck 70 adapted to releasably retain the cutting tool 65 is mounted on an end 72 of the spindle shaft. An actuator 74, shown in the illustrated embodiment as a pneumatic cylinder, includes a cylinder rod 76 through which the spindle shaft 66 passes. The presser foot support 58 is mounted on an end 78 of the cylinder rod 76. When the spindle shaft 66 is positioned in the cylinder rod 76, the bearing journal 68 adjacent the chuck 70 engages an inner race of a bearing 80 mounted on the end 78 of the cylinder rod. A sleeve 82 is also mounted to the cylinder rod 76 at the end opposite the chuck 70. The sleeve 82 is lightly pressed onto and then pinned to the cylinder rod. A bearing 84 engages the sleeve and the spindle shaft 66. In the preferred embodiment bearings 80 and 84 are thrust needle bearings being preloaded by tensioning nut 100. While a pneumatic actuator has been shown and described, the present invention is not limited in this regard as other actuators known to those skilled in the pertinent art which the present invention pertains, such as a hydraulic cylinder, can also be employed.

Still referring to FIG. 5, each driven pulley 22 defines a bore 86 extending therethrough. The bore 86 is stepped and includes a needle bearing 88 positioned in one end. The sleeve 82 is adapted to be received in the bore 86 with the needle bearing 88 engaging the outer periphery of the sleeve. A key 90 is positioned in keyway 92 defined by the spindle shaft 66 and engages a keyway 95 in bushing 94 which in turn extends partway into the driven pulley 22 and is fastened thereon via fasteners 96. When assembled, the spindle shaft 66 extends through the driven pulley 22 and defines a threaded end 98. A nut 100 engages the threaded end 98 thereby tying the spindle assembly 14 together, and preloads bearings 80 and 84. During operation, the cylinder 74 pneumatically is actuated via ports 99, to move the cutting tool installed in the chuck 72 into engagement with the media to be drilled. Each of the three spindles 66 is independently movable via commands issued from a controller, not shown, in communication with the triple drill 10.

During operation, as a spindle assembly is lowered, the first and second belts, 24 and 26 respectively, slide along the driven pulleys 22 in order to maintain alignment with the drive pulley 20. To facilitate this movement, the driven pulleys 22 are chrome plated and a lubricant, such as silicon is applied. Accordingly during movement of a spindle assembly, the first and second belts, 24 and 26 essentially remain stationary with the driven pulley 24 moving relative thereto.

While preferred embodiments have been shown and described, various modifications and substitutions may be made without departing from the spirit and scope of the invention. Accordingly, it is to be understood that the present invention has been described by way of example, and not by limitation.

What is claimed is:

1. A drive train bearing assembly comprising:
an actuator having a shaft defining a longitudinal axis, said shaft being movable between an extended position and a retracted position and defining an axial bore extending therethrough;
a spindle positioned in said bore and coupled for rotation to said actuator shaft;
a pulley defining an axial bore extending therethrough and having a bearing positioned therein;
said pulley being positioned over said actuator shaft such that said bearing and thereby said pulley are coupled for rotation relative thereto; and wherein
said spindle is coupled to said pulley so that said pulley and spindle rotate together relative to said actuator shaft.

2. A drive train bearing assembly as defined by claim 1 further comprising:
a bearing coupled to a first end of said actuator shaft; and wherein
said spindle when positioned in said actuator shaft engages said first bearing and is rotatable relative to said actuator shaft.

3. A drive train bearing assembly as defined by claim 2, further comprising:
a sleeve fixedly mounted to and approximately coaxial with said actuator shaft; said longitudinal axis;
a second bearing positioned in said sleeve bore and coupled to said sleeve, said second bearing adapted to rotatably receive a portion of said spindle; and wherein said pulley is positioned over and approximately coaxial with said sleeve so that said bearing positioned in said pulley rotatably engages said sleeve.

4. A drive train bearing assembly as defined by claim 1, further comprising
a sleeve fixedly mounted over an end of said actuator shaft;
a bearing positioned in said axial bore defined by said pulley, said pulley being positioned over said sleeve; and wherein
said bearing engages said sleeve so that said pulley is rotatable relative thereto.

5. A drive train bearing assembly as defined by claim 1, further comprising a cutting tool chuck mounted onto an end of said spindle.

6. A drive train bearing assembly as defined by claim 1 wherein said actuator is a pneumatic cylinder.

7. A drive train bearing assembly as defined by claim 1 wherein said actuator is a hydraulic cylinder.

8. A drive train bearing assembly comprising:
an actuator having a shaft defining a longitudinal axis, said shaft being movable between an extended position and a retracted position and defining an axial bore extending therethrough;
a sleeve positioned over an end of said actuator shaft and secured thereto, said sleeve being approximately coaxial with said longitudinal axis;
a first bearing positioned in said bore of said sleeve;
a second bearing coupled to said actuator shaft at an end opposite said sleeve;
a spindle extending through said axial bore defined by said actuator shaft and rotatably engaged with said first and second bearings;
a pulley positioned over said sleeve and coupled to an end of said spindle; and
a third bearing extending between said sleeve and said pulley, so that said pulley and thereby said spindle are rotatable relative to said actuator shaft

9. A drive train bearing assembly as defined by claim 8 further comprising:
said pulley defining a bore extending therethrough and approximately coaxial with said longitudinal axis; and
a bushing coupled to said pulley and said spindle.

10. A drive train bearing assembly as defined by claim 9, wherein:
said spindle defines a first keyway;
said bushing defines a second keyway; and wherein said drive train bearing assembly further comprises
a key positioned in said first and second keyways thereby coupling said spindle to said bushing and thereby to said pulley.
